(19) United States
(12) Patent Application Publication
(10) Pub. No.: US 2013/0016585 A1
(43) Pub. Date: Jan. 17, 2013

(54) VARIABLE POWER FISH FINDER

(71) Applicant: DAVID A. CRAIG, Owasso, OK (US)

(72) Inventor: DAVID A. CRAIG, Owasso, OK (US)

(21) Appl. No.: 13/550,275

(22) Filed: Jul. 16, 2012

Related U.S. Application Data
(60) Provisional application No. 61/508,289, filed on Jul. 15, 2011.

(51) Int. Cl. G01S 15/96; H04B 1/02

(52) U.S. Cl. 367/107; 367/137

(57) ABSTRACT

A device having a digital controller, a power amplifier, a sonar transducer, and a sonar receiver communicatively coupled to the digital controller. The digital controller provides a power control signal to the power amplifier, which in turn drives the sonar transducer at a level determined in real time by the digital controller to prevent excessive noise from being detected by the sonar receiver.

### CROSS REFERENCE TO RELATED APPLICATIONS

This application claims the priority of U.S. Provisional Patent Application No. 61/508,289 entitled “INTELLIGENT FISH FINDER,” filed Jul. 15, 2011, the contents of which are hereby incorporated by reference.

### FIELD OF THE INVENTION

This disclosure relates to fishing sports in general and, more particularly, to electronic fish finding.

### BACKGROUND OF THE INVENTION

Fish finders have been on the market for some time. These are usually sonar based with a transducer providing a “ping” and then determining the location and shape of underwater features, or the bottom surface, based upon the return echo. Normally, when a fish finder is powered on, a high power ping is produced by the transducer. Depth will be unknown to the fish finder at this time and a relatively high power ping is needed to establish depth. However, in shallow water or under other conditions, a high power ping is capable of producing an unacceptable noise in the return signal that can be detected by the transducer and provide unsatisfactory readings.

What is needed is a system and method for dealing with the above, and related issues.

### SUMMARY OF THE INVENTION

The invention of the present disclosure, in one aspect thereof, comprises a device having a digital controller, a power amplifier, a sonar transducer, and a sonar receiver communicatively coupled to the digital controller. The digital controller provides a power signal to the power amplifier, which in turn drives the sonar transducer at a level determined in real time by the digital controller to prevent excessive noise from being detected by the sonar receiver.

In one embodiment, the digital controller increases the power signal to the power amplifier in response to loss of a predetermined level of return sonar echo being detected by the sonar receiver. The digital controller may increase the power signal to the power amplifier in response to detecting no echo at the sonar receiver, or it may increase the power signal to the power amplifier in response to an increase in speed of a watercraft to which the sonar transducer is mounted. In other embodiments, the digital controller decreases the power signal to the power amplifier in response to detecting multiple return echo signals from a water boundary. In some embodiments, the digital controller accepts user input for control of the power control signal. The display screen, the power amplifier, and the digital controller may be integrated into a display unit for mounting on a watercraft.

The invention of the present disclosure, in another aspect thereof comprises a device with a display unit having a display screen, a digital controller communicatively coupled to the display screen, and a power amplifier receiving power signals from the digital controller. The device has a sonar transducer for transmitting sonar signals into water in response to electrical power from the power amplifier, and a sonar receiver for receiving return echo sonar signals from the water. The digital controller receives return echo signals from the sonar receiver and displays corresponding graphical information to the display screen. The digital controller alters the power output of the sonar transducer in response to a state of return echo signals received or not received by the sonar received. In some embodiments, the digital controller accepts user input for control of the power control signal.

The power output alteration may occur in real time. The digital controller may increase the power signal to the power amplifier in response to loss of a predetermined level of return sonar echo being detected by the sonar receiver. In another embodiment, the digital controller increases the power signal to the power amplifier in response to detecting no echo at the sonar receiver. The digital controller may also increase the power signal to the power amplifier in response to an increase in speed of a watercraft to which the sonar transducer is mounted.

In some embodiments, the digital controller decreases the power signal to the power amplifier in response to detecting multiple return echo signals from a water boundary. The power signal to the transducer may start at a first, high level upon initial activation and may be lowered by the digital controller until only a single echo from a water boundary is detected by the receiver.

The invention of the present disclosure, in another aspect thereof, comprises a method including providing a digital controller with an output signal to a power amplifier, providing a sonar transducer powered by the power amplifier, and providing a sonar receiver communicatively coupled to the digital controller. The method includes adjusting the output signal to the power amplifier such that return echo noise detected by the sonar receiver is below a predetermined threshold.

The method may also include increasing the power signal to the power amplifier in response to loss of a predetermined level of return sonar echo being detected by the sonar receiver; increasing the power signal to the power amplifier in response to detecting no echo at the sonar receiver; and/or increasing the power signal to the power amplifier in response to an increase in speed of a watercraft to which the sonar transducer is mounted. In some embodiments, the method comprises operating the transducer at a first, high level upon initial activation and lowering the power level until only a single echo from a water boundary is detected by the receiver.

### BRIEF DISCRIPTION OF DRAWINGS

FIG. 1A is a schematic diagram of a fish finding sonar system.

FIG. 1B is a schematic diagram of another fish finding sonar system.

FIG. 2 is an environmental view of the fish finding sonar system of FIG. 1A mounted for use on a boat.

FIG. 3 is a block diagram of a fish finding sonar system with communication and control channels illustrating an operational mode with fixed power output.

FIG. 4 is a block diagram of a fish finding sonar system with communication and control channels illustrating an operational mode with adjustable power output.

FIG. 5 is a flow chart illustrating a power feedback mechanism for a fish finding sonar system according to aspects of the present disclosure.

### DESCRIPTION OF THE PREFERRED EMBODIMENTS

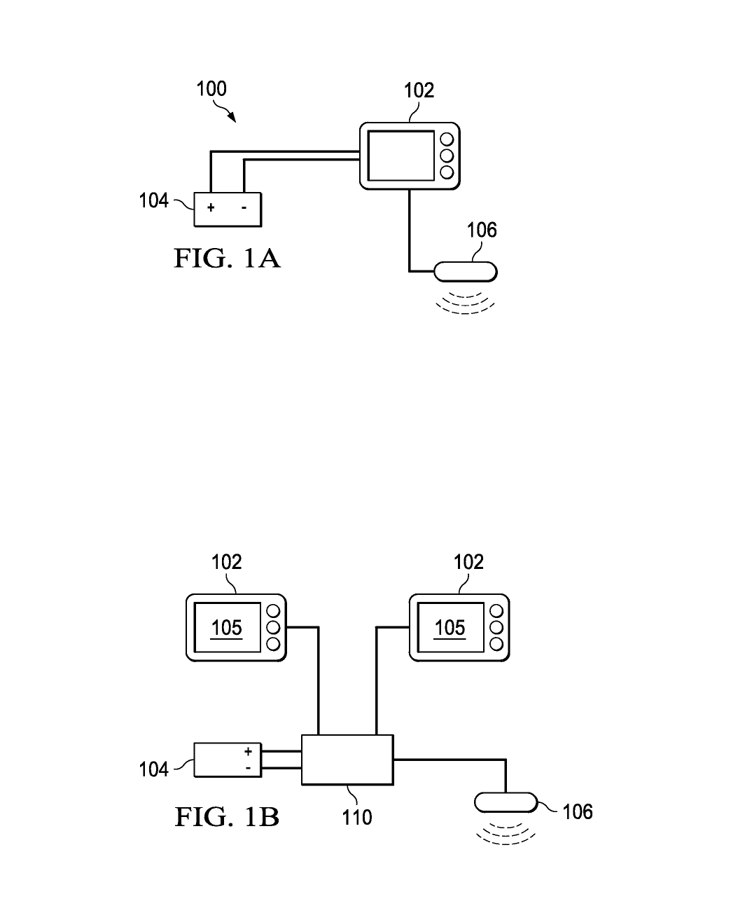

Referring now to FIG. 1A, a schematic diagram of a fish finding sonar device is shown. Sonars utilized for purposes of locating fish below the surface of the water are often referred to as “fish finders.” The fish finder system 100 of FIG. 1A comprises a display and processing unit 102. The unit 102 is the physical housing that contains most of the operational electronics of the system 100. The display unit 102 also provides at least one display screen and various user accessible controls. In some embodiments, the display screen 102 may also function as an input device (e.g., it may be capacitive or pressure sensitive).

The display unit 102 is powered by an electrical power supply 104. In some embodiments, the power supply 104 comprises a battery that may be located on a boat. The display unit may attach to the battery 104 via direct wiring, an auxiliary or power outlet (not shown), or other means. In other embodiments, the power supply 104 may actually be internal to the display unit 102 to allow operation when an outside power supply is not available. In such embodiments, an electrical connection may be provided for recharging of the power supply 104 from the boat, or a land-based electrical outlet.

The display unit 102 is also communicatively coupled to transducer 106. The coupling provides for power and/or electronic communications between the transducer and the display unit. In some embodiments, the transducer 106 acts as both a sonar emitter and a sonar detector. The transducer 106 may be a piezoelectric device that emits a sonar pulse in response to being electrically energized by the display unit 102. The transducer 106 will also produce a corresponding voltage as a result of absorbing reflected energy from within the water. This information is utilized by the display unit 102 to display information to a user. The information may be user selectable and may include bottom depth, fish location, and other information.

Referring now to FIG. 1B, a schematic diagram of another fish finding sonar system 101 is shown. The operation of the system 101 is substantially similar to that of FIG. 1A. It will be appreciated that the control functions and methods described below will function equally well with the system 101 of FIG. 1B. The system 101 provides a sonar module 110 that may contain all or part of the operational electronics needed by the system 101. In some embodiments, the sonar module 110 connects to the power supply 104. The sonar module is coupled to the transducer/receiver 106 and may connect to multiple display units 102, each having a screen 105. Here, one display unit is shown with a single control 103. It will be appreciated that this configuration is meant to be illustrative rather than limiting as in some embodiments each display unit 105 may have a control, or neither may have a control.

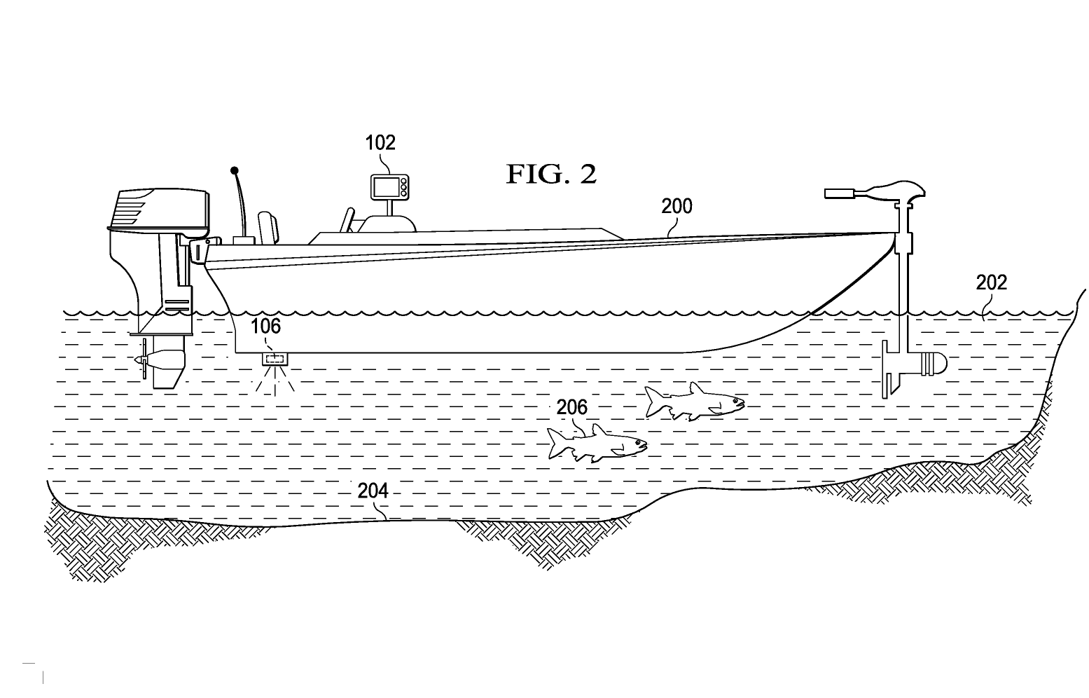

Referring now to FIG. 2, an environmental view of the fish finding sonar system of FIG. 1A mounted for use on a boat is shown. It should be understood that FIG. 2 is not to scale nor necessarily indicative of the full range of terrain and fish that the system may be able to detect. The display unit 102 may be mounted in a convenient, use accessible location on a boat 200. The boat 200 may be a personal sized fishing boat or kayak, or may be capable of supporting multiple fishermen, or even a large commercial setup.

In some embodiments, the transducer 106 will be mounted below the structure of the boat 200, beneath the surface of the water 202. The transducer 106 could also be mounted within the boat (not actually in the water), on a trolling motor, or another location. The transducer 106 emits sonic waves (sonar) into the water and detects return echoes from the water boundaries such as the surface 202 and/or ground 204. Receiving return echoes from water boundaries may be important for determining the location and depth of the ground 204, for example. However, as explained in further detail below, when the boundaries are detected multiple times, it may be that more sonar energy than needed is being utilized. Excess or multiple return echoes from the same water boundary may be considered “noise” that must be addressed or accounted for by the sonar system 100. Importantly, the transducer 106 and system 100 also detect fish 206, and/or other subsurface structures.

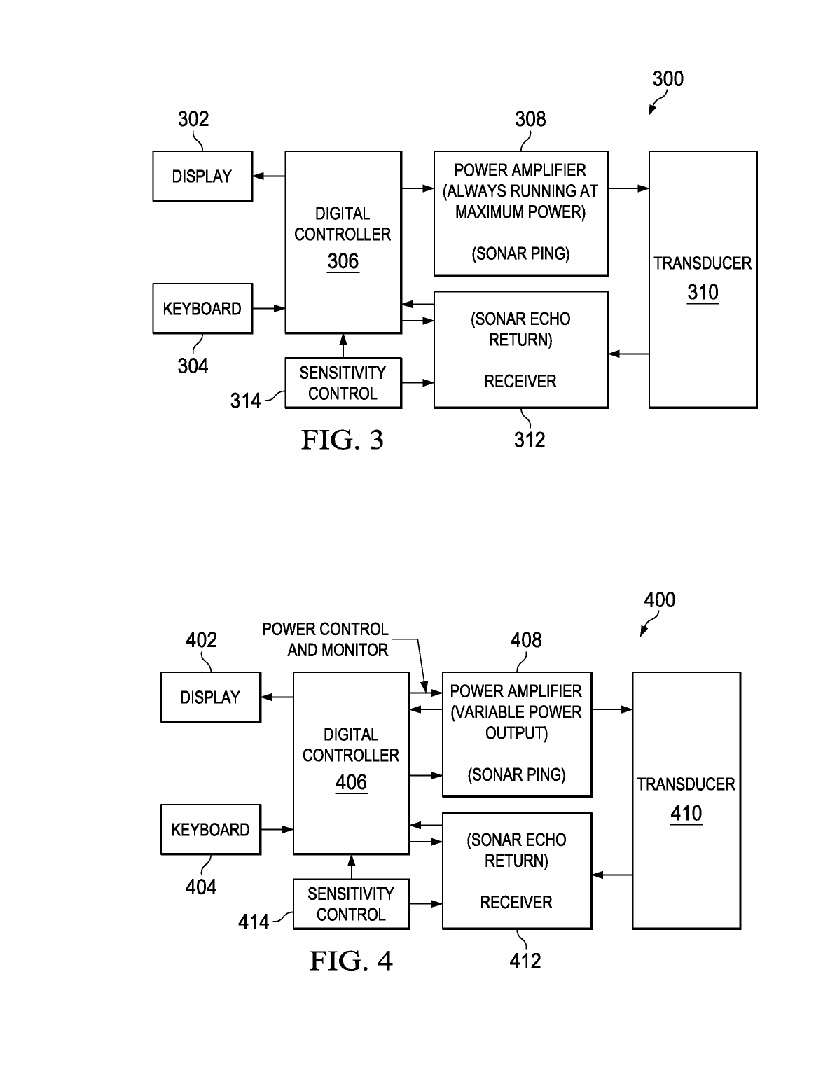

Referring now to FIG. 3, is a block diagram of a fish finding sonar system with communication and control channels illustrating an operational mode with fixed power output is shown. The system 300 comprises a display receiving data from a digital controller 306. The controller may accept input from a keyboard 304. The controller 306, display 302, and keyboard 304 may be integral with the display unit (102, FIG. 1A). In some embodiments, the digital controller 306 is a solid state device and may be at least partially programmable. The controller 306 provides control signals to a power amplifier 308 that may also be incased in the display unit 102. The amplifier 308 may be based on an integrated circuit and provide the appropriate voltage and current for driving the transducer 310 (shown as 106 in FIGS. 1A, 1B and 2).

The transducer 310, relying on power from the amplifier 308, emits sonar waves or signals into the water. The echo or echoes from the sonar signal is received by the receiver 312. Although shown here as a separate logical component, in some embodiments, the transducer 310 and the receiver 312 may be housed in the same housing, or may even be the same piezoelectric component (as described above with respect to FIG. 1A).

In operation, prior fish finders on the market have operated at power up by providing a high intensity ping from the transducer 310 into the water when powered on. In other words, the power amplifier 308 is driven at or near its maximum. Since depth is unknown when the device 300 is powered up, a high intensity ping will ensure that the bottom is reached and detected by the fish finder receiver 312. However, in the event that the fish finder 300 is operating in shallow water, the return signal (echo) will be quite intense. It may be detected multiple times by the receiving transducer 312 as it bounces between the bottom and the water/air boundary. The signal will also contain a lot of noise. In such a system 300, the sensitivity of the receiver 312 may be turned down to avoid multiple return echoes from the same ping, and to reduce the noise in the signal which would be detrimental to an accurate display reading. This relationship is shown logically by the sensitivity control setting 314. Physically, the sensitivity control 314 will be implemented by the digital controller 306 integrated into the display unit 102.

Stated another way, the greater the output power of the fish finder 300, the deeper the fish finder 300 will track the bottom, and track fish. However, the greater the power, the more energy is being placed into the water and as the depth gets shallower, the fish finder 300 may actually be putting too much energy into the water. This extra energy may be seen as noise by the receiver 312 and has to be overcome. Reduction of the receiver/input sensitivity is one way to handle this. However, this solution results in the condition that when the fish finder 300 is operating in shallower water, the sensitivity of the finder 300 is decreased, while it may be much greater in in deeper water. Previously, very elaborate “chirps” of sonar output bursts (customized pings) have been attempted to try to identify the original signal reflection from the multiple reflections caused by the excess power injected into the water. (It is understood though, that the systems of the present disclosure may also employ chirps or customized pings, but these may not be needed for purposes for which they were previously used, e.g., determining the original signal reflection from the noise.)

Referring now to FIG. 4, a block diagram of a fish finding sonar system with communication and control channels illustrating an operational mode with adjustable power output is shown. The system 400 provides a digital controller 406 with a display 402 and a keyboard 404. Here again, these components may be integrated into the display unit 102 (FIG. 1A). A power amplifier 408 is controlled by the controller 406 to provide the appropriate voltage and current to drive the transducer 410. Sonar waves are produced and the echoes are detected by the receiver 412. Again, the transducer 410 and receiver 412 may be integrated wholly, or at least share a housing. The return echo signals are provided to the digital controller for processing and display on the display 402. Once again, sensitivity control 412 may be provided, and may be part of the digital controller 412 and/or user controls.

In some embodiments, such as that shown in FIG. 4, rather than reducing the sensitivity of the receiver 412, the power output of the transducer 408 is reduced. Power control and monitoring of the power amplifier 408 by the digital controller 406 may be achieved as illustrated by the two-way communication path shown in FIG. 4. In this manner, when a high intensity ping is needed (e.g., in deep water) it may be provided based upon feedback from the receiver 412. However, in conditions where the ping is producing a lot of noise in the echo, the transducer 410 may be operated at a lower level. By operating the transducer 410 at the lowest level capable of providing an adequate return signal, noise is avoided. Furthermore, the display resolution and quality for the user improves.

The digital controller 406 logic of the fish finder 400 may automatically adjust the power output, possibly according to feedback from the receiver 412. The fish finder 400 may also allow the user to manually adjust the power output if he or she so desires (e.g., via the keyboard 404 and/or display 402). In some embodiments, the power output is controlled by varying the power amplifier 408 section of the fish finder's 400 circuitry. This may be done by programmable hardware and/or software routines executed in the digital controller 406 and/or other components.

In some embodiments of the fish finder 400, as the device moves into shallower water, output power is reduced so that sensitivity can stay at maximum (or at least at a very high level). This will allow more detail to be detected by the receiver 412, which may be operated at a much higher sensitivity that a fixed power fish finder. This, in turn, allows more detail and information to be displayed for the user on the display 402. In some embodiments, the current power output and/or sensitivity may be displayed to the user as well. Advanced users may prefer to adjust output and receiver sensitivity manually, and this may be offered through the keyboard 404 and/or display 402. There will be numerous ways within the purview of one of skill in the art in which the power output of the transducer 410 can be varied. The present disclosure is not intended to be limited to particular circuitry.

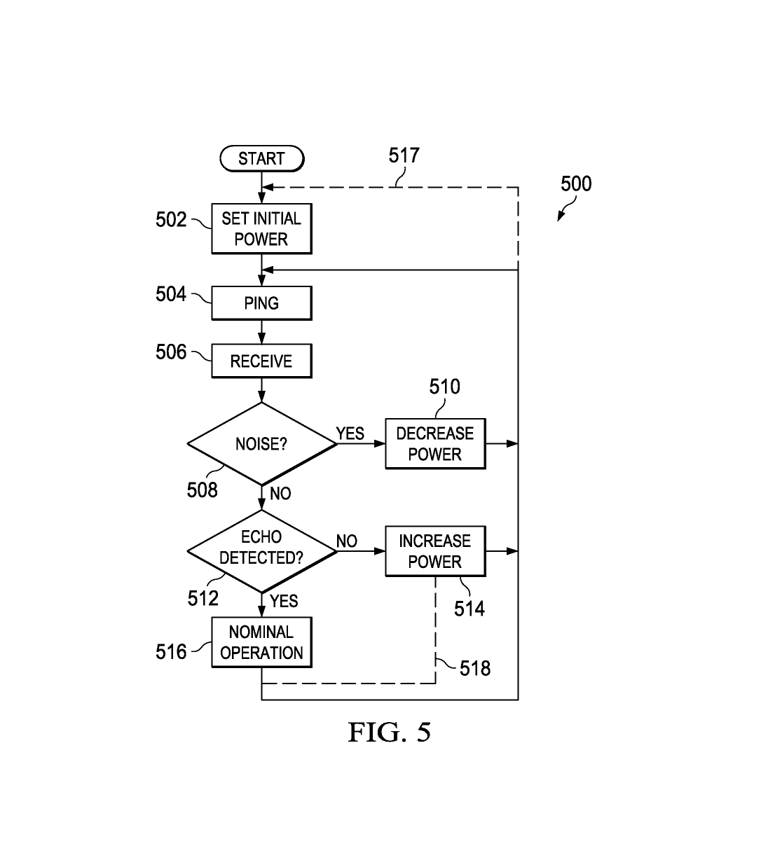

Referring now to FIG. 5, is a flow chart illustrating a power feedback mechanism for a fish finding sonar system according to aspects of the present disclosure is shown. In order to ensure that power output is maintained at an appropriate level, a feedback mechanism may be employed. The feedback and adjustment of power output may occur in real time, such that a user does not have to be involved. The initial power for the amplifier 408 and transducer 400 may be set at startup at step 502. In some embodiments, this will be a high power setting to produce a ping at step 504 that is certain to detect the bottom. In such cases, a large echo may be received at step 506 that is indicative of the bottom floor of the body of water. The echo, if of sufficient magnitude, can rebound off the surface of the water where it meets the air. This can create another readable echo on the transducer that becomes noise (e.g., because it is not indicative of an actual structure in the water). With sufficient power remaining in the ping, it can travel to the bottom and be reflected and detected yet again. This cycle can repeat a number of times and still be detectable by the transducer, particularly if a high strength ping is used in shallower waters. The logic of the digital controller 406 may detect such noise at step 508.

If unacceptable noise is detected at step 508, power may be decreased at step 510 and the ping repeated at step 504. In order to avoid having the secondary echoes display on the fish finder 400, the magnitude of the output is reduced until noise and unwanted secondary echoes are avoided. If, after a time, or even at startup, no echo is detected at step 512, power can be increased at step 514. In some embodiments, particularly where the power setting is initially set to maximum, the power level may be returned to its initial setting by proceeding back to step 502 from step 514 as shown by dotted line 516. In effect, this results in the digital controller 406 continuously monitoring the return signal from the transducer 412 to ensure that the signal is powerful enough to be useful, but not so powerful as to produce unacceptable noise. The levels may be programmed with a built in hysteresis to prevent continual adjustment of the power level. In other words, an acceptable range of nominal operation may be achieved (step 516) where the signal is neither being increased, nor decreased.

It is understood that “nominal operation” here refers to a state where pings are regularly being produced in order to receive usable information from the transducer 412. During nominal operation, the digital controller may continue to monitor for noise (e.g., step 508) so that power can be reduced if and when noise is detected. After a predetermined period of nominal operation, a power increase may be attempted as shown by dotted line 518. Thus, if the boat has moved, or conditions have otherwise changed that would allow for a higher power output without unacceptable noise, power will be increased. Modern integrated circuitry that may be used to implement the digital controller 406 operates at sufficient speed that the aforementioned adjustments may occur without the user taking notice.

In other embodiments, the digital controller 406 may be programmed to operate the power output such that a primary ground return echo of a predetermined strength is received. The predetermined strength may be chosen such that no secondary or noise echoes are produced, yet the output of the transducer 410 remains high enough that good resolution of deep objects is achieved (e.g., steps 508 and 512). When deeper or shallower water is encountered, power may be adjusted accordingly. Similarly, when travelling and higher power is needed to maintain resolution, the digital controller 406 can increase power while in motion and decrease power when the craft slows.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A device comprising:
a digital controller;
a power amplifier;
a sonar transducer; and
a sonar receiver communicatively coupled to the digital controller;
wherein the digital controller provides a power control signal to the power amplifier, which in turn drives the sonar transducer at a level determined in real time by the digital controller to prevent excessive noise from being detected by the sonar receiver.

2. The device of claim 1, wherein the digital controller increases the power control signal to the power amplifier in response to loss of a predetermined level of return sonar echo being detected by the sonar receiver.

3. The device of claim 1, wherein the digital controller increases the power control signal to the power amplifier in response to detecting no echo at the sonar receiver.

4. The device of claim 1, wherein the digital controller increases the power control signal to the power amplifier in response to an increase in speed of a watercraft to which the sonar transducer is mounted.

5. The device of claim 1, wherein the digital controller decreases the power control signal to the power amplifier in response to detecting multiple return echo signals from a water boundary.

6. The device of claim 1, wherein the digital controller accepts user input for control of the power control signal.

7. The device of claim 6, wherein the display screen, the power amplifier, and the digital controller are integrated into a display unit for mounting on a watercraft.

8. A device comprising:
a display unit having a display screen, a digital controller communicatively coupled to the display screen, and a power amplifier receiving power control signals from the digital controller;
a sonar transducer for transmitting sonar signals into water in response to electrical power from the power amplifier; and
a sonar receiver for receiving return echo sonar signals from the water;
wherein the digital controller receives return echo signals from the sonar receiver and displays corresponding graphical information to the display screen; and
wherein the digital controller alters the power output of the sonar transducer in response to a state of return echo signals received or not received by the sonar received.

9. The device of claim 8, wherein the digital controller alters the power output of the sonar transducer in real time.

10. The device of claim 8, wherein the digital controller increases the power signal to the power amplifier in response to loss of a predetermined level of return sonar echo being detected by the sonar receiver.

11. The device of claim 8, wherein the digital controller increases the power signal to the power amplifier in response to detecting no echo at the sonar receiver.

12. The device of claim 8, wherein the digital controller increases the power signal to the power amplifier in response to an increase in speed of a watercraft to which the sonar transducer is mounted.

13. The device of claim 8, wherein the digital controller decreases the power signal to the power amplifier in response to detecting multiple return echo signals from a water boundary.

14. The device of claim 8, wherein the power signal to the transducer is at a first, high level upon initial activation and is lowered by the digital controller until return echo noise drops below a predetermined threshold.

15. The device of claim 8, wherein the digital controller accepts user input for control of the power control signal.

16. A method comprising:
providing a digital controller with a power control signal to a power amplifier;
providing a sonar transducer powered by the power amplifier;
providing a sonar receiver communicatively coupled to the digital controller; and
adjusting the output signal to the power amplifier such that return echo noise detected by the sonar receiver is below a predetermined threshold.

17. The method of claim 16, further comprising increasing the power control signal to the power amplifier in response to loss of a predetermined level of return sonar echo being detected by the sonar receiver.

18. The method of claim 16, further comprising increasing the power control signal to the power amplifier in response to detecting no echo at the sonar receiver.

19. The method of claim 16, further comprising increasing the power signal to the power amplifier in response to an increase in speed of a watercraft to which the sonar transducer is mounted.

20. The method of claim 16, further comprising operating the transducer at a first, high level upon initial activation and lowering the power level until only a single echo from a water boundary is detected by the receiver.
